(19) United States
(12) Patent Application Publication
(10) Pub. No.: US 2015/0324737 A1
(43) Pub. Date: Nov. 12, 2015

(54) DETECTION OF ERRONEOUS ONLINE LISTINGS

(71) Applicant: CarGurus, Inc., Cambridge, MA (US)

(72) Inventors: Oliver I. Chrzan, Somerville, MA (US); Matthew L. Passell, Waltham, MA (US)

(21) Appl. No.: 14/273,967

(22) Filed: May 9, 2014

(51) Int. Cl. G06Q 10/08; G06Q 30/00

(52) U.S. Cl. CPC G06Q 10/087; G06Q 30/018

(57) ABSTRACT

An aggregated online listing of vehicles or other items for sale is improved by identifying and removing potentially erroneous or fraudulent listings such as listings that are likely outdated or listings that include an unrealistic price. A variety of techniques may be used to identify these listings based upon historical sales data. For example, a decaying time model may be used to determine if a listed item should have sold after a certain period of time. As another example, a popularity model may be used to determine if a listed item should have sold after a certain number of views.

### RELATED APPLICATIONS

This application is related to commonly-owned U.S. application Ser. No. 13/906,981 filed on May 31, 2013, the entire content of which is hereby incorporated by reference.

### FIELD OF THE INVENTION

This application relates to detection of erroneous online listings, and more specifically to techniques for identifying erroneous or fraudulent vehicle listings.

### BACKGROUND

A variety of online services provide vehicle buyers with information about a population of vehicles for sale. While useful to shoppers, these services do not readily account for erroneous or fraudulent vehicle listings, which can be distracting and wasteful to a potential buyer. For example, in order to lure a potential buyer to a vehicle seller's website or place of business, sellers have been known to list vehicles for sale at a price that is well under market value. Then, when the potential buyer visits the website or place of business, the advertised vehicle is unavailable and the potential buyer is pressured to consider different, higher-priced vehicles. The identification and removal of such bogus listings, as well as the identification of sellers who provide such listings, may be highly relevant to a purchaser evaluating a listing of vehicles.

There remains a need for improved techniques to aggregate vehicle listings in a manner that filters fraudulent or erroneous listings.

### SUMMARY

An aggregated online listing of vehicles or other items for sale is improved by identifying and removing potentially erroneous or fraudulent listings such as listings that are likely outdated or listings that include an unrealistic price. A variety of techniques may be used to identify these listings based upon historical sales data. For example, a decaying time model may be used to determine if a listed item should have sold after a certain period of time. As another example, a popularity model may be used to determine if a listed item should have sold after a certain number of views.

In one aspect, a method includes providing a model characterizing historical sales of a vehicle type based upon one or more attributes of the vehicle type, and aggregating a number of listings for sale of a number of vehicles of the vehicle type, thereby providing a list of vehicles. The method may further include applying the model to the listings to identify one of the listings as a potentially erroneous listing, and removing the potentially erroneous listing from the list of vehicles to provide a revised list of vehicles that excludes the potentially erroneous listing.

### BRIEF DESCRIPTION OF THE DRAWINGS

The foregoing and other objects, features and advantages of the devices, systems and methods described herein will be apparent from the following description of particular embodiments thereof, as illustrated in the accompanying figures. The figures are not necessarily to scale, emphasis instead being placed upon illustrating the principles of the devices, systems, and methods described herein.

FIG. 1 shows entities participating in a system for identifying erroneous listings.

FIG. 2 shows a web page that includes vehicle listings.

FIG. 3 is a flow chart of a method for identifying erroneous or fraudulent vehicle listings.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein. Rather, these illustrated embodiments are provided so that this disclosure will convey the scope to those skilled in the art.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it will be understood that terms such as “first,” “second,” “above,” “below,” and the like, are words of convenience and are not to be construed as limiting terms.

Described herein are techniques for identifying erroneous vehicle listings. As used throughout this disclosure, the term “erroneous” is generally intended to describe a listing that is either intentionally incorrect (e.g., “fraudulent,” or “misleading”) or accidentally incorrect (e.g. “bogus”) due to user input error or other data error or inconsistency. While the characteristics of these listings may vary according to whether they are intentionally misleading or simply a result of sloppy data entry, they may be readily identified wherever the sale (or non-sale) of a particular item deviates significantly from expected sales behavior. As such, the principles described herein apply to any form of erroneous listing that results in deviations from expected sales patterns, and the above terms and similar language should be understood to include all such forms of erroneous listing unless a different meaning is explicitly provided or otherwise clear from the context. For example, if a method includes a step of “identifying an erroneous listing,” this step would also include identifying a fraudulent listing, a bogus listing, and the like.

The descriptions herein emphasize techniques for identifying erroneous vehicle listings (e.g., listings of used automobiles for sale). However, it should be understood that the implementations described herein may be applied to other vehicles such as motorcycles, sport utility vehicles, light trucks, trucks, and the like, and that the implementations may also or instead be readily adapted for new vehicles. More generally, the implementations described herein may be usefully employed in any context where it is desirous for erroneous items (i.e., any items listed for sale) to be identified based on historical data and removed from a listing of items.

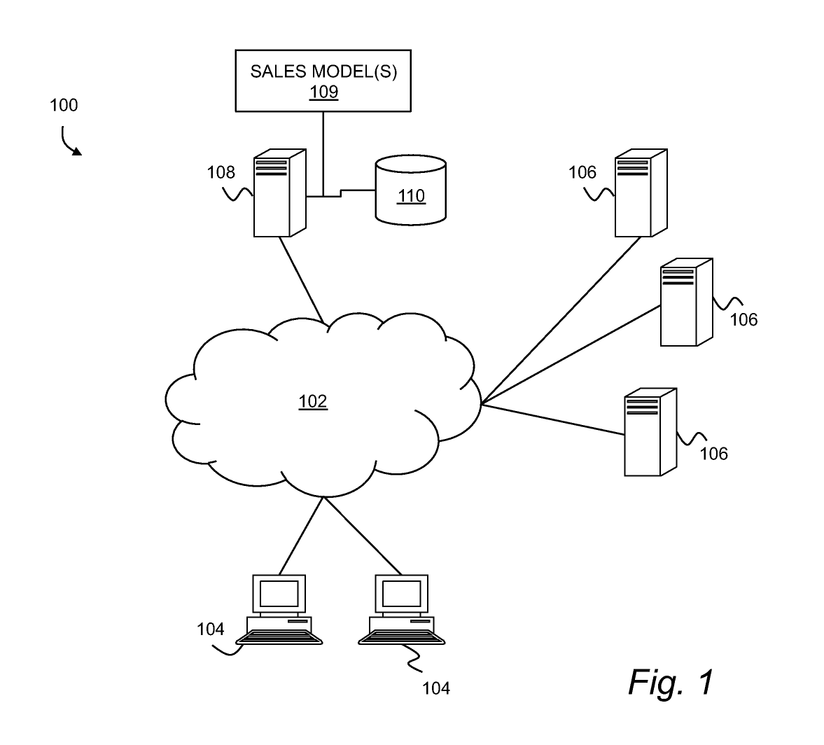

FIG. 1 shows entities participating in a system for identifying erroneous listings. It will be understood that the entities and components shown in FIG. 1 may also include, or be included in a pricing or scoring system, for example, any of the systems described in commonly-owned U.S. application Ser. No. 13/906,981 filed on May 31, 2013, which claims the benefit of U.S. App. No. 61/776,202 filed on Mar. 11, 2013. Each of these applications is hereby incorporated by reference in its entirety.

As shown in FIG. 1, the system 100 may include a data network 102 such as the Internet that interconnects any number of clients 104, data sources 106, and a server 108 (which may include a database 110 or multiple databases). In general, the server 108 may secure data from the various data sources 106 such as dealer listings and other third party data sources, and construct models 109, e.g., models characterizing historical sales of vehicles. These models 109 may also or instead be provided to the server 108, e.g., from a client 104 or other source, or they may be stored in the database 110. These models 109 can be derived from historical sales data and employed to predict vehicle sales and detect unusual sales activity to assist in identifying and removing potentially erroneous listings such as listings that are outdated, listings that include an unrealistic price, and the like. In this manner, the server 108 can respond to inquiries from clients 104 with accurate lists of vehicles offered for sale, where the lists exclude erroneous listings. Elements of the system 100 are described in greater detail below.

The data network 102 may include any network or combination of networks suitable for interconnecting other entities as contemplated herein. This may, for example, include the Public Switched Telephone Network, global data networks such as the Internet and World Wide Web, cellular networks that support data communications (such as 3G, 4G and LTE networks), local area networks, corporate or metropolitan area networks, wide area wireless networks, and so forth, as well as any combination of the foregoing and any other networks suitable for data communications, for example, between the clients 104, the data sources 106, and the server 108.

The clients 104 may include any device(s) operable by end users to interact with the server 108 through the data network 102. This may, for example, include a desktop computer, a laptop computer, a tablet, a cellular phone, a smart phone, and any other device or combination of devices similarly offering a processor and communications interface collectively operable as a client device within the data network 102. In general, a client 104 may interact with the server 108 and locally render a user interface such as a web page or the like supporting interaction by the end user with services provided by the server 108.

The data sources 106 may include any sources of data useful for detecting and removing erroneous listings as contemplated herein. In one aspect, this may include dealer listings, which may be provided as a data feed, database, or the like available through the data network 102 using a suitable programming interface. In another aspect, dealer listings may be obtained from a website using scraping, bots, or other automated techniques. Dealer listings may include information useful for modeling, or information otherwise relevant to identifying erroneous listings for a particular vehicle including, without limitation, a vehicle price, a vehicle type (e.g., make or model), a vehicle mileage, a vehicle year (of manufacture), a vehicle trim (e.g., option packages, features, etc.), a vehicle transmission, a vehicle condition, a vehicle interior/exterior color, a vehicle history (accident/repair history, fleet history, etc.), a new vehicle, a used vehicle, and so forth. Dealer listings may include other information useful to consumers for decision making but not directly quantitatively applicable to a model for identifying and removing erroneous listings. For example, a listing may include photographs of a vehicle, a narrative description of the vehicle prepared by the dealer, seller contact information, a location of the vehicle, and the like. Such information may also be retrieved from the dealer website for use when presenting aggregated listings from the server 108 to a user at a client 104.

In another aspect, data sources 106 may include third party data providers. For example, a variety of commercial services are available that provide vehicle history such as a repair history, fleet history (use in a rental fleet or commercial fleet of vehicles), flood damage history, and so forth. Where data such as a vehicle identification number is available in dealer listings, such data may be used to directly match the vehicle to various listings or other vehicle data. Other techniques can be used to correlate such third party data to vehicle listings or otherwise infer vehicle condition or history. Other data such as data provided by government agencies may, where available, provide useful information relating to vehicle title, vehicle inspection history, vehicle mileage, vehicle accident history, and so forth.

The data sources 106 may also or instead include sources of information from third parties regarding dealer reputation. For example, a variety of services, websites, and the like, are available that provide dealer ratings, rankings, reviews, past sales, experience, and so forth. Other techniques can be used to correlate such third party data to vehicle listings or otherwise infer dealer reputation. Other data may be useful regarding dealer reputation such as data provided by government agencies or public records relating to, e.g., fines, lawsuits, criminal records, and the like.

The server 108 may in general be configured as described above to create one or more price models using data obtained from the data sources 106, and to respond to user inquiries from the clients 104 with ranked lists and other data. In embodiments, the server 108 may employ multilinear regression analysis to derive a pricing model that relates vehicle price to various vehicle attributes. The resulting model may take the general form:

yᵢ=β₁xᵢ₁+β₂xᵢ₂+ . . . +βₚxᵢₚ+εᵢ[Eq. 1]

where xᵢⱼ is the i^{th} observation on j^{th} independent variable (where the first independent variable takes the value 1 for all i). A model may be created, for example, for each vehicle type, and the regression parameters, \hat{β}, for each such model may be calculated for independent variables such as the condition, the mileage, the year, and so forth from the data sources 106. It will be readily appreciated that, while the residual error may be minimized for any given data set, the goodness of fit for a model and the statistical significance of the estimated parameters may be subject to review, and the model may be revised, e.g., by the addition or removal of parameters or the removal of outlier observations, until an adequate model is obtained. Such a process may be manual, automated, or some combination of these, and may be informed by subjective or objective characterizations of the quality of the resulting model. Suitable objective criteria for various models may include a standard error, an R-squared analysis of residuals, an F-test of overall fit, and a t-test for individual regression parameters.

It will be understood that a variety of other statistical techniques such as nonlinear regression, curve-fitting, and so forth may be appropriate in various data modeling contexts. More generally, a wide range of modeling techniques are known in the art for predictive analysis including, without limitation, neural networks, fuzzy logic models, case-based reasoning, rule-based systems, regression trees, and so forth, any of which may be employed to computationally derive suitable predictive algorithms for fair market value. Furthermore, numerous computational techniques are known for estimating parameters for a regression model including, without limitation, percentage regression, least absolute deviations, nonparametric regression, distance metric learning, and so forth, any of which may be suitably employed for various types of populations or data sets. Still more generally, these techniques are provided by way of non-limiting examples, and any such techniques or other techniques, as well as combinations of the foregoing, may be usefully adapted to obtain predictive models for vehicle price that can be implemented by the server 108. All such variations are intended to fall within the scope of the term “model” as used herein unless a different meaning is explicitly provided or otherwise clear from the context.

However derived, a price model may be stored in the database 110 along with underlying data for vehicle listings. The server 108 may be configured to calculate fair market value according to the price model, and to provide this information to clients 104, such as in the form of a ranked list of vehicles for sale. The list may be ranked according to a price score that provides a dimensionless, numerical representation of relative value. In one embodiment, a price score, S, for a vehicle may be calculated as:

$$S = \frac{{P}_{fm} - {P}_{l}}{σ} \qquad [ Eq . 2 ]$$

where P_{fm} is the fair market value of the vehicle (as calculated using the price model), Pₗ is the list price at which the vehicle is offered for sale (according to the vehicle listing), and σ is the standard deviation for the price model. A list of results ranked according to the price score may be transmitted from the server 108 to one of the clients 104, along with related data for each vehicle (photos, narrative description, attributes, etc.) so that a user of the client 104 can browse listings and compare vehicles listed for sale.

It will be understood that while a single server 108 is depicted in FIG. 1, any number of logical servers or physical servers may be used as the server 108 according to, e.g., server traffic, desired level of service, and so forth. Similarly, server functionality may be divided among different platforms in a number of ways. For example, one server or group of servers may be used to obtain data from the data sources 106 and create price models for various vehicle types. Another server or group of servers may be configured to provide a web interface for receiving and responding to client requests for vehicle price information using the price model(s) created by the first group of servers. Any such configuration suitable for responding to clients 104 based upon user-provided parameters and data obtained from the data sources 106 may be employed as the “server” described herein.

One or more sales models 109 may also or instead be created and applied by the server 108 to characterize historical sales data. In general, the server 108 may apply the sales model(s) 109 to identify and filter out erroneous listings. For example, a sales model 109 may be a time decay model in which historical sales are modeled as a percentage of available items that sell per unit of time (e.g., per hour, per day, per week, etc.), or a corresponding time constant for the resulting decay in available listings. In another aspect, a popularity model may also or instead be employed that estimates a likelihood of sale based on a number of views of a listing, or some similar quantity, so that a particular listing can be evaluated for likelihood of a sale.

Having described a platform that may be used in the identification of erroneous or fraudulent listings of vehicles for sale, this description now turns to an example of a web page that includes vehicle listings.

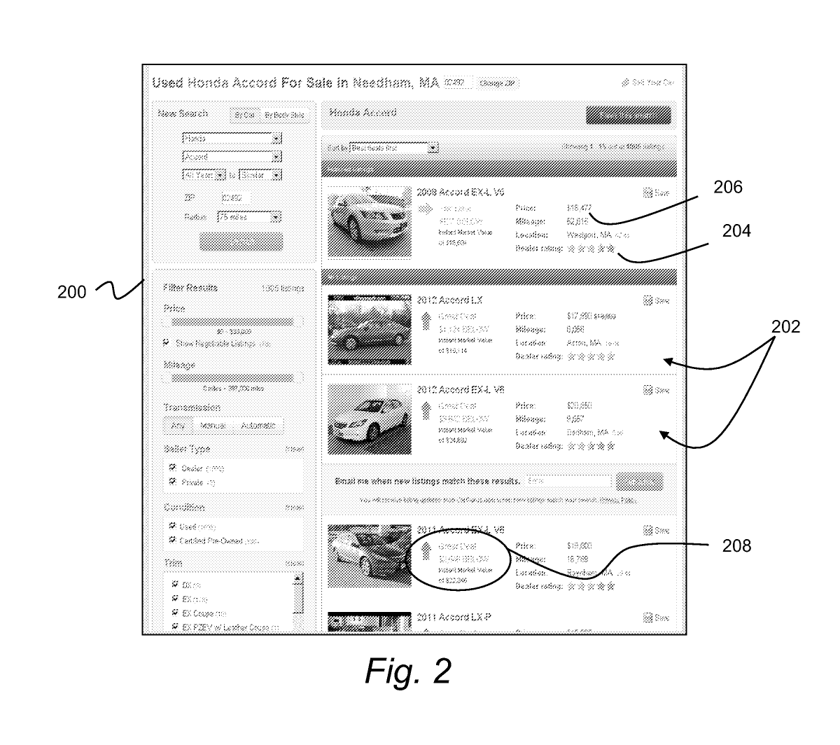

FIG. 2 shows a web page 200 that contains ranked vehicle listings. The ranked vehicle listings may exclude erroneous vehicle listings. Alternatively, the ranked vehicle listings may include erroneous listings (e.g., erroneous listings have yet to be removed or erroneous listings are flagged as such for a user of the web page 200). The web page 200 may be transmitted from a server (such as any of the servers described above) to a client (such as any of the clients described above). The web page 200 may include a number of listings 202 ranked according to relative value and/or adjusted for dealer reputation as described herein.

Each listing 202 may include additional data such as a dealer rating 204, a list price 206, a deal quality score 208, and any other information characterizing a particular listing or information about the listed vehicle. A listing 202 may include an erroneous listing or potentially erroneous listing as contemplated herein. In one aspect, a listing 202 that has been identified as potentially erroneous may be visually flagged with text, graphics, or the like to alert a viewer of the web page 200 to possible issues.

The dealer rating 204 may include may include various representations of a dealer's quality and reputation such as a graphic (e.g., stars, arrows, dollar signs, etc.), text (e.g., “Great Dealer,” “Fair Dealer,” etc.), a quantitative reputation score (e.g., “99/100”, etc.), a grade (e.g., “A+”, etc.), or any other representation or combination of representations of the dealer's reputation. The dealer's rating 204 may be provided through the use of a variety of data gathering techniques which may be used alone or in combination with one another. In one aspect, this may include transmitting a number of surveys to a number of purchasers of vehicles and processing responses to the surveys to determine the dealer reputation for the corresponding dealers. Such data may be conveniently gathered for purchasers who shop for and purchase vehicles using the server described herein through the use of automated electronic surveys or the like, and such survey information may be gathered during an online interaction related to the purchase, or in a subsequent communication such as an electronic mail or the like sent to purchasers after completing transactions that were initiated through the server. In such a survey, a dealer may be evaluated against one or more criteria using an objective scale (e.g., one to five), and the results may be aggregated in any suitable manner for each dealer.

The deal quality score 208 may include various representations of deal quality such as text (e.g., “Great Deal,” “Fair Deal,” etc.), a graphic (e.g., an up arrow, down arrow, or sideways arrow), a quantitative statement of value (e.g. “$1,134 BELOW fair market value,” “Top Ten!,” “top ten percent,” etc.), a grade (e.g., “A+,” etc.), a number (e.g., “99/100,” etc.), or any other representation or combination of representations of the quality of each listing.

The web page 200 may also include a variety of tools to provide or revise search parameters including, for example, sliders to specify ranges, drop down lists to select from among a number of options, text boxes to enter search terms and check boxes to specify use of various filters, and so forth. More generally, any controls that can be used to parameterize user input within a web page or other interface may be used to gather user input specifying a vehicle search. The web page 200 may also include a tool to identify or single-out erroneous listings for a user.

In general, the web page 200 may include any list of vehicles described herein, for example, a list of vehicles that includes one or more erroneous listings, a list of vehicles in which erroneous vehicles have been removed, or a list of vehicles showing the erroneous listings identified by the techniques described herein. The list of vehicles may include a number of vehicles responsive to a request (e.g., meeting the various parameters of the request), and may be ranked according to any suitable metric. The ranking may be based upon a relative value, for example, using a comparison between a fair market price and a listing price for each of the number of vehicles, or using a comparison between dealer reputation and a listing price for each of the number of vehicles. Other criteria may also be used to rank the list, including the expected purchasing experience for the vehicle. That is, one vehicle having certain attributes may be more or less desirable than another vehicle with the same attributes because of the differences in the dealers offering each vehicle for sale, even though the vehicles are objectively identical (and therefore of equal value). In order to address such noneconomic factors, rankings may be adjusted to account for additional information. Or stated slightly differently, vehicles may be ranked using a scoring system that accounts for such factors in addition to a price model that is based upon objective vehicle attributes. The relative value may be a dimensionless value normalized according to a standard deviation of prices for the number of vehicles.

In general, listings that are identified as erroneous or potentially erroneous using the techniques described herein may be removed or filtered from the listings so that they are not presented to users. The source of the erroneous listing may also be notified or, where the source consistently provides listings that appear erroneous, the source may be removed entirely as a source of listings for the web page.

Having described a web page that includes vehicle listings, this description now turns to a technique for identifying and removing erroneous vehicle listings.

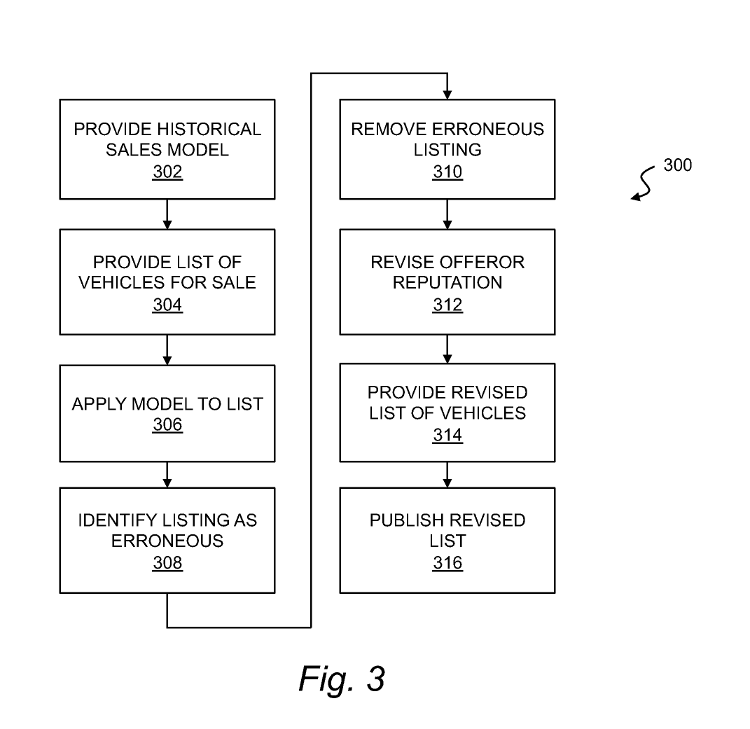

FIG. 3 shows a flow chart of a method 300 for identifying erroneous or fraudulent vehicle listings.

As shown in step 302, the method 300 may include providing a model characterizing historical sales of a vehicle type based upon one or more attributes of the vehicle type. The historical sales may be sales over a time period specified by the user, or another predetermined time period, which may be a default time period. The historical sales may also be specified with any other useful criteria, such as sales for specific geographic regions.

The vehicle type may be specified with any useful or desired degree of granularity. For example, the vehicle type may be a make and a model of vehicle, and may further include a standard trim package or other description that explicitly or implicitly identifies other characteristics of the vehicle type. The attributes may also or instead specify a vehicle in any useful manner. For example, the attributes may include a vehicle mileage (from an odometer reading), a vehicle interior/exterior color, an ownership history, a location, a vehicle price, a vehicle year (of manufacture), option packages, features, a vehicle transmission, a vehicle condition, a vehicle history (accident/repair history, fleet history, etc.), and so forth.

In general, the model may be any statistical or other mathematical or algorithmic model for characterizing historical sales. For example, the model may be a decay model such as a decaying time model that characterizes a percentage of vehicles of the vehicle type that sell in a time period. This may be mathematically modeled, for example, as an exponential decay of the general form:

N(t)=N₀e^{-λt} [Eq. 3]

where N₀ is an initial amount at t=0, λ is the decay constant, and N(t) is an amount at time, t. It will be understood that calculating the time decay constant (or the corresponding time constant) may be complicated somewhat when the source data includes a continuous supply of new listings, however, the various techniques for addressing this are well known in the art and the details are omitted here for simplicity.

It will also be understood that even with a suitably obtained and accurate decay model, some discretion may be appropriate in selecting a duration of a listing beyond which the listing will be presumed to be erroneous. For example, at some time value, the quantity indicated by the model may be a non-integer value less than one. This hypothetical fractional car might still reasonably be available for sale if the value is closer to one than to zero. But at some point, the amount becomes suitably small enough to accurately infer an error. This may be a fixed threshold (e.g., N(t)<0.5), or this may be a variable threshold depending, for example, on the rate of decay. However determined, the model may indicate at some time, t, that the amount of vehicles or other listings of a particular type are expected to be zero, and any listing older than this duration can appropriately be characterized as erroneous.

In another aspect, the model may be a popularity model. The popularity model may use a popularity metric to estimate a likelihood of sale as a function of a number of views of a listing. The popularity model may, for example, determine the number of views of one of the listings and calculate the likelihood of sale based on the number of views. Any similar metric may be used as an independent variable for such a model, including phone calls to a dealer, text messages to a dealer, electronic mail messages to a dealer, or some combination of these, any of which may imply a corresponding likelihood of sale of a listed item. The model may be fashioned in a variety of ways, and may, for example, use a “raw” metric such as the total number of phone calls or sales calls, without regard to the particular listed item, or the model may use a more specifically tailored metric such as phone calls involving inquiries about a specific listing or group of listings, which may be automatically detected or manually logged.

In this manner, a potentially erroneous listing can be identified by the model, for example, if the likelihood of sale for the one of the listings exceeds a threshold. The threshold may be a calculated threshold or a predetermined threshold. For example, the predetermined threshold may be at least about 0.99. The calculated threshold may be determined according to a current number of listings or any other suitable constraint. The popularity model may take into account various vehicle attributes, for example, any of the attributes of the vehicle described herein. It will be appreciated that mathematically this popularity model may be similar to the decay model described above, except that the independent variable is the number of views rather than time. In addition, the probability of a sale would asymptotically approach one rather than zero as the number of views increases (although the popularity may also be modeled with a dependent variable approaching zero, such as a number or remaining vehicles or a probability that an automobile has not sold).

As shown in step 304, the method 300 may include providing a list of vehicles for sale, which may involve aggregating a number of listings for sale of a number of vehicles of the vehicle type. The listings for sale may be aggregated in any suitable manner known in the art, and the listings for sale (and associated information) may be retrieved from any sources described herein or otherwise known in the art (e.g., dealer websites, auction listings, etc.). The listings for sale may be aggregated for a particular vehicle type, which may be limited by any of the criteria described herein, which may be inputted by a user. Additionally or alternatively, the listings for sale may be aggregated for a particular vehicle attribute(s). By way of example, all red convertibles manufactured in the previous five years and located within twenty five miles of a user's location may be aggregated. The number of listings for sale may be limited to a predetermined amount, which limit may be applied before, during, or after aggregating. The list of vehicles may be published on a data network and viewed by a user on a client device, or otherwise be made available to users.

In general, providing a list of vehicles may occur after receiving a request for vehicle information from a client. For example, a user may post a request to a web page from a client device that specifies a vehicle make, model, trim, mileage, year, and other attributes to narrow or define a search. Attributes may be specified in a variety of ways such as with a range of possible values (e.g., for mileage, year, or list price) or as a filter to include or exclude certain attributes such as a vehicles having a certain trim, feature, option package, or the like. The server may aggregate responsive listings and transmit them to the requester in any suitable format. Where a server provides data for both new and used vehicles, these categories may be modeled differently, and a web site or other interface for configuring the user inquiry may request this information first. More generally, techniques for gathering information interactively from a user of a client device and providing responsive results are well known in the art, and such techniques may be used in any suitable manner to parameterize a user request for vehicle information and provide corresponding results.

As shown in step 306, the method 300 may include applying a model to the list. Applying the model may include identifying one of the listings that has a predetermined likelihood of containing an error. The predetermined likelihood that the listing has an error may be determined with a time decay or popularity model as described herein based upon any suitable criteria including, without limitation, the age of the listing or the number of views of the listing. Other factors such as dealer reputation may be used to determine thresholds or otherwise adjust results. In an implementation including a decay model, applying the model may include calculating an amount of time for a remaining number of listings to decay to below a predetermined threshold such as an amount smaller than one vehicle, or an amount sufficiently close to zero. Any listing older than this calculated amount of time may be identified as erroneous. That is, if the age of a listing is greater than the amount of time for all of a particular type of vehicle to have sold, then an erroneous listing may be inferred and the listing may be handled accordingly. In an implementation including a popularity model, applying the model may include determining the number of views of one of the listings and calculating the likelihood of sale based on the number of views. Applying the model may further include identifying one of the listings that potentially contains an error when the likelihood of sale for the one of the listings exceeds a predetermined threshold such as a very high likelihood (e.g., about 0.99 or about 0.999). As with a time decay model, other parameters such as dealer reputation, sales volume, and the like may be used to adjust the predetermined threshold or otherwise adjust results as appropriate.

As shown in step 308, the method 300 may include identifying one of the listings as a potentially erroneous listing, for example, based on an application of the model(s) described herein. In general, the potentially erroneous listing may include a listing with an error, which may be a clerical mistake or the like. The potentially erroneous listing may also or instead include a fraudulent listing, for example, a listing meant to lure a potential buyer to a vehicle seller's website or place of business by pricing a vehicle well under market value. Characteristics of fraudulent listings versus erroneous listings may be used to characterize the identified listing accordingly. This data may be stored for later use in identifying ongoing fraudulent behavior, confirming or correcting errors, and so forth.

As shown in step 310, the method 300 may include removing the potentially erroneous listing from the list of vehicles. The removal of the listing may include permanently deleting the listing, temporarily deleting the listing, or moving the listing to a database including potentially erroneous listings. Removing the potentially erroneous listing may include automatically removing the potentially erroneous listing, manually removing the potentially erroneous listing, or some combination of these. For example, removing the potentially erroneous listing may include automatically reporting the potentially erroneous listing to an administrator for manual review, who may then manually review the listing and decide whether or not to remove the listing. In general, the use of objective criteria for a final determination is amenable to automated application by a computer while subjective criteria may be more readily applied through manual intervention. However, a variety of techniques based upon machine learning, fuzzy logic, and the like may also or instead be employed to automate final determinations when a potentially erroneous listing is identified using the models described herein.

Removing the potentially erroneous listing may include extracting, deleting, or otherwise expunging the listing from an aggregated vehicle listing, and may include storing the listing in a database for subsequent processing or analysis. In another aspect, the listing may be left in an aggregated list and visually flagged with an icon or the like to alert a consumer to potential issues.

As shown in step 312, the method 300 may include revising a reputation of an offeror of the potentially erroneous listing. In general, the reputation of an offeror may include any of the factors described herein with reference to a dealer rating. The reputation data may be accumulated over long periods of time, and may remain relevant for extended periods. Thus, this data may be gathered and updated incrementally as new erroneous listings are identified, new survey data becomes available, or on some scheduled or other periodic basis (e.g., once per hour, once per day, once per week, or on any other suitable schedule). Revising the reputation of an offeror may occur only after a fraudulent listing is identified, or a certain number of erroneous or fraudulent listings are identified or confirmed. The revised reputation may be used to adjust a position of one of the vehicles in a ranked list according to the reputation, thereby providing an adjusted ranked list. More generally, one, some, or all of the vehicles may receive an adjusted ranking according to a dealer reputation for each corresponding listing.

As shown in step 314, the method 300 may include providing a revised list of vehicles that excludes the potentially erroneous listing. This may include providing the revised list to a user through a client device or otherwise publishing the revised list, e.g., through a data network. This may include providing associated data such as any of the vehicle data described herein, along with metadata such as photographs, narrative description, contact information, a location where the vehicle is offered for sale (and/or available for inspection), and the like. As noted above, the revised list may instead flag any potentially erroneous listings.

As shown in step 316, the method 300 may include publishing the revised list. Publishing the revised list may further include providing a searchable database of the listings in the revised list. Publishing the revised list may also or instead include offering the revised list of vehicles for sale on a web site. Publishing the revised list may also or instead include sending the revised list to a user, e.g., through an electronic mail, to a user's phone, or the like.

It will be appreciated that the methods disclosed with reference to FIG. 3 may be deployed in the system disclosed with reference to FIG. 1 to provide a vehicle listing evaluation system that includes a database and a server configured to receive a request from a client for vehicle information and to transmit to the client a vetted adjusted ranked list (without erroneous listings) that is responsive to the request. The database may, for example, store one or more models used to identify erroneous listings according to a number of parameters, as well as updated source data excluding any potentially erroneous listings. The database may store information pertaining to the plurality of models for different vehicles along with individual vehicle listings. A server providing aggregated listings as contemplated herein may also be configured to adjust a position of one of the vehicles in a ranked list according to a dealer reputation that has been adjusted based on the identification of potentially erroneous listings. This may be used in combination with other dealer reputation information obtained, e.g., from surveys or the like.

The above systems, devices, methods, processes, and the like may be realized in hardware, software, or any combination of these suitable for the control, data acquisition, and data processing described herein. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same. In another aspect, means for performing the steps associated with the processes described above may include any of the hardware and/or software described above. All such permutations and combinations are intended to fall within the scope of the present disclosure.

It should further be appreciated that the methods above are provided by way of example. Absent an explicit indication to the contrary, the disclosed steps may be modified, supplemented, omitted, and/or re-ordered without departing from the scope of this disclosure.

The method steps of the invention(s) described herein are intended to include any suitable method of causing such method steps to be performed, consistent with the patentability of the following claims, unless a different meaning is expressly provided or otherwise clear from the context. So for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

1. A method comprising:
providing a model characterizing historical sales of a vehicle type based upon one or more attributes of the vehicle type;
aggregating a number of listings for sale of a number of vehicles of the vehicle type, thereby providing a list of vehicles;
applying the model to the listings to identify one of the listings as a potentially erroneous listing; and
removing the potentially erroneous listing from the list of vehicles to provide a revised list of vehicles that excludes the potentially erroneous listing.

2. The method of claim 1 wherein applying the model includes identifying one of the listings having a predetermined likelihood of containing an error.

3. The method of claim 1 further comprising publishing the revised list on a data network.

4. The method of claim 3 wherein publishing the revised list includes providing a searchable database of the listings in the revised list.

5. The method of claim 1 wherein the model includes a decaying time model that characterizes a percentage of vehicles of the vehicle type that sell in a time period.

6. The method of claim 5 wherein applying the model includes calculating an amount of time for a remaining number of listings to decay to less than a predetermined threshold and wherein the potentially erroneous listing is one of the listings older than the amount of time.

7. The method of claim 5 wherein applying the model includes calculating an amount of time for a remaining number of listings to decay to less than a predetermined threshold and wherein the potentially erroneous listing is one of the listings having an age at least as great as the amount of time.

8-12. (canceled)

13. The method of claim 1 wherein removing the potentially erroneous listing includes automatically removing the potentially erroneous listing.

14. The method of claim 1 wherein removing the potentially erroneous listing includes reporting the potentially erroneous listing to an administrator for manual review.

15. The method of claim 1 further comprising identifying the potentially erroneous listing as a potentially fraudulent listing.

16. The method of claim 1 wherein the one or more attributes include a year of manufacture.

17. The method of claim 1 wherein the one or more attributes includes an odometer reading.

18. The method of claim 1 wherein the one or more attributes includes one or more of a repair history and a fleet history.

19. The method of claim 1 further comprising offering the revised list of vehicles for sale on a web site.

20. The method of claim 1 further comprising revising a reputation of an offeror of the potentially erroneous listing.
